(19) United States
(12) Patent Application Publication
(10) Pub. No.: US 2013/0050076 A1
(43) Pub. Date: Feb. 28, 2013

(54) METHOD OF RECOGNIZING A CONTROL COMMAND BASED ON FINGER MOTION AND MOBILE DEVICE USING THE SAME

(71) Applicants: Kwang-Seok HONG, Gwacheon-si (KR); Byung Hun OH, Seoul (KR); Joon Ho AHN, Seoul (KR)

(72) Inventors: Kwang-Seok HONG, Gwacheon-si (KR); Byung Hun OH, Seoul (KR); Joon Ho AHN, Seoul (KR)

(73) Assignee: RESEARCH & BUSINESS FOUNDATION SUNGKYUNKWAN UNIVERSITY, Suwon-si (KR)

(21) Appl. No.: 13/591,933

(22) Filed: Aug. 22, 2012

Related U.S. Application Data
(60) Provisional application No. 61/663,524, filed on Jun. 22, 2012.

(30) Foreign Application Priority Data
Aug. 22, 2011 (KR) 10-2011-0083425

(51) Int. Cl. G06F 3/033

(52) U.S. Cl. 345/157

(57) ABSTRACT

Provided is a method of recognizing a control command from a finger movement detected from an image capturing apparatus of a mobile device, involving: capturing an image of a finger, determining a contour of the finger from the captured image, determining coordinates of a pointer that corresponds to a region of the finger based on the contour, and recognizing a control command based on a movement direction of the finger, a length of time for which the pointer is positioned on an object, or a change in the contour of the finger.

### CROSS-REFERENCE TO RELATED APPLICATIONS

This application is a non-provisional application of U.S. Provisional Application No. 61/663,524, filed on Jun. 22, 2012, in the United States Patent and Trademark Office, that claims priority to and claims the benefit under 35 U.S.C. §119(a) of Korean Patent Application No. 2010-0083425, filed on Aug. 22, 2011, in the Korean Intellectual Property Office. The entire disclosures of the earlier filed applications are incorporated herein by reference for all purpose.

### BACKGROUND

1. Field

The following description relates to a method of recognizing a control command based on the movement of a finger and a mobile device that allows a user to control a pointer by moving his or her finger.

2. Description of Related Art

Depending on the circumstances in which a user is using a portable information device, it is sometimes desirable to control the portable information device and related contents embedded in the portable information device with the use of only one hand, or to control the contents without touching the screen or using a key pad.

A method of utilizing a user's gesture as an interface command using an image capturing apparatus disposed on the back of a portable information device has been proposed. In this method, the portable information device is simply used to recognize a gesture.

### SUMMARY

In one general aspect, there is provided a method of recognizing a control command from a finger movement detected from an image capturing apparatus of a mobile device, involving: capturing an image of a finger, determining a contour of the finger from the captured image, determining coordinates of a pointer that corresponds to a region of the finger based on the contour, and recognizing a control command based on a movement direction of the finger, a length of time for which the pointer is positioned on an object, or a change in the contour of the finger.

The control command corresponding to the length of time for which the pointer is positioned on the object may be an object selection command to drag and drop the object, and the object selection command may be triggered in response to the pointer being positioned on the object for a predetermined length of time or more.

The mobile device may be configured to perform a vibration feedback when the pointer is positioned on the object for the predetermined length of time or more.

In the general aspect, the determining of the contour may include determining a region of the captured image depicting the finger based on a threshold value indicating a skin color, removing noise by binarizing the image, and determining the contour of the finger from the image from which the noise is removed, and the determining of the coordinates of the pointer may include a shape analysis in which a central line of the finger is determined from the contour, and associating of a tip portion of the central line with the coordinates of the pointer.

The control command corresponding to the change in the contour of the finger may be a command in which the object is clicked with the pointer when a size of the finger is determined to increase or decrease based on the contour while the pointer is positioned on the object.

In the general aspect, the recognizing of a control command may further include recognizing an operation of the pointer as a control command for clicking the object when there is a frame having a rapid change in a size of the finger among frames constituting images including the finger.

In another general aspect, there is provided a mobile device for recognizing a control command based on an image of a finger, including: an image capturing unit configured to capture an image including a finger, a pointer extraction unit configured to determine a contour of the finger from the captured image and determine coordinates of a pointer that corresponds to a region of the finger based on the contour, and a control command generation unit configured to generate a control command based on a movement direction of the pointer, a length of time for which the pointer is positioned on an object, or a change in the contour of the finger.

The control command generation unit may be configured to generate an object selection command to drag and drop the object with the pointer in response to the pointer being positioned on the object for a predetermined length of time or more.

The control command generation unit may be configured to perform a vibration feedback when generating the object selection command.

The pointer extraction unit may be configured to determine a region of the image corresponding to the finger based on a threshold value indicating a skin color, to remove noise by binarizing the image, and to determine the contour of the finger from the image from which the noise has been removed, to perform a shape analysis to determine a central line of the finger and to associate a tip portion of the central line of the finger with coordinates of the pointer.

The control command generation unit may be configured to generate a control command for clicking the object when a size of the finger is determined to increase or decrease based on the contour while positioned on the object among frames constituting images including the finger.

In yet another general aspect, there is provided a mobile device for recognizing a control command based on an image of a finger, including an image capturing unit configured to capture an image including a finger, and a processing unit configured to determine a contour of the finger from the captured image and determine coordinates of a pointer corresponding to a region of the finger based on the contour, in which the processing unit is configured to generate an object selection command to drag and drop an object with the pointer in response to the pointer being positioned on the object for a predetermined length of time or more, and to generate an object drop command in response to a predetermined length of time or more having elapsed after position movement by dragging the object.

The selection command and the drop command of the general aspect of mobile device may include a vibration feedback.

The coordinates of the pointer may be determined by applying a shape analysis to the contour of the finger.

The shape analysis applied in the general aspect of mobile device may be a skeletonization to determine a topological skeleton from the contour.

Other features and aspects may be apparent from the following detailed description, the drawings, and the claims.

### BRIEF DESCRIPTION OF THE DRAWINGS

FIG. 1 is a flowchart illustrating an example of a method of recognizing a control command according to the movement of a finger.

FIG. 2 is a flowchart illustrating an example of a pointer recognition method.

FIG. 3 is a diagram illustrating an example of a method in which a pointer is associated with a region of a finger.

FIG. 4 is a diagram illustrating an example of a method of recognizing a pointer movement control command.

FIG. 5 is a diagram illustrating an example of a method of moving and controlling an object according to the movement of a pointer.

FIG. 6 is a diagram illustrating an example of a method of recognizing a click control command.

FIG. 7 is a diagram illustrating an example of a method of recognizing an “up” control command.

FIG. 8 is a diagram illustrating an example of a method of recognizing a “down” control command.

FIG. 9 is a diagram illustrating an example of a method of recognizing a “right” control command.

FIG. 10 is a diagram illustrating an example of a method of recognizing a “left” control command.

FIG. 11 is a diagram illustrating an example of a method of recognizing a drag and drop control command.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

The terminology used herein is for the purpose of describing a number of examples for illustrative purposes and is not intended to limit the scope of the claims.

As used herein, the singular forms “a,” “an,” and “the” are intended to include the plural forms as well, unless the context indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless the context clearly indicates a specific order, steps may occur out of the noted order. That is, the steps may be executed in the same order as noted, the steps may be executed substantially concurrently, or the steps may be executed in the reverse order.

Unless otherwise defined, terms used herein, including the technical and scientific terms, have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Described herein are a mobile device and a method capable of efficiently controlling the mobile device and the content running on the mobile device by acquiring and recognizing finger motions or the positional changes in a finger pointer and the like within a two-dimensional (2D) plane or a multi-dimensional space region, from an image of a finger region for which planar or multi-dimensional analysis is possible using a fixed or removable image capturing unit provided in the mobile device.

In an example, a pointer corresponding to a finger region is acquired and recognized using an image capturing apparatus provided in a mobile device. For example, the pointer may indicate a center point or coordinates of a fingertip serving as a recognition target through the image capturing apparatus.

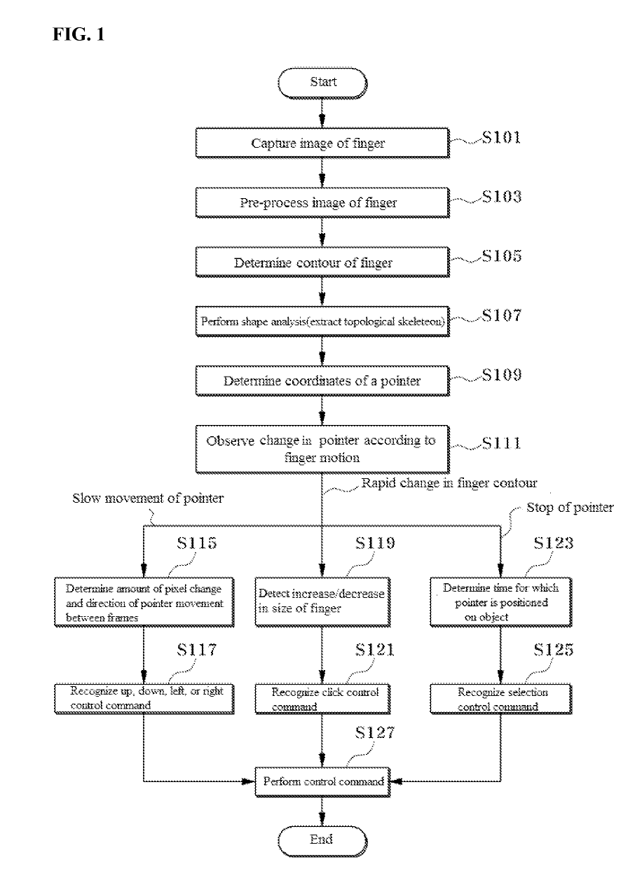

Hereinafter, an example of a method of recognizing the pointer and recognizing control commands according to motions of the pointer will be described with reference to FIGS. 1 to 11.

FIG. 1 is a flowchart illustrating an example of a method of recognizing the location of a pointer and recognizing a control command initiated by a user based on the movement of a finger. As illustrated in FIG. 1, the method of recognizing the location of the pointer based on the movement of a finger may include step S101 of acquiring an image of a user's finger, step S103 of pre-processing the image of the finger, step S105 of extracting a contour of the finger, step S107 of performing a shape analysis such as skeletonization on the image, and step S109 of extracting coordinates of the pointer from the finger image.

In this example, in step S101, an image of a finger may be captured to extract a pointer location by acquiring the motion of an index finger. For instance, the index finger may have a relatively high degree of freedom even when the hand is holding a mobile device with other fingers. On some mobile devices, the camera is located in the rear side of the screen, and the image of the index finger may be captured through such a rear-facing camera of the mobile device. In steps S103 to S109, a pre-processing of the image of the finger may be performed to change a color of the image, to extract a region of a skin having certain color, and/or to perform a binarization of the image data, from the captured image of the finger. Subsequently, a central line or a topological skeleton may be extracted from the image of the finger by determining a contour of the finger region and performing a shape analysis, such as skeletonization, using information regarding the contour.

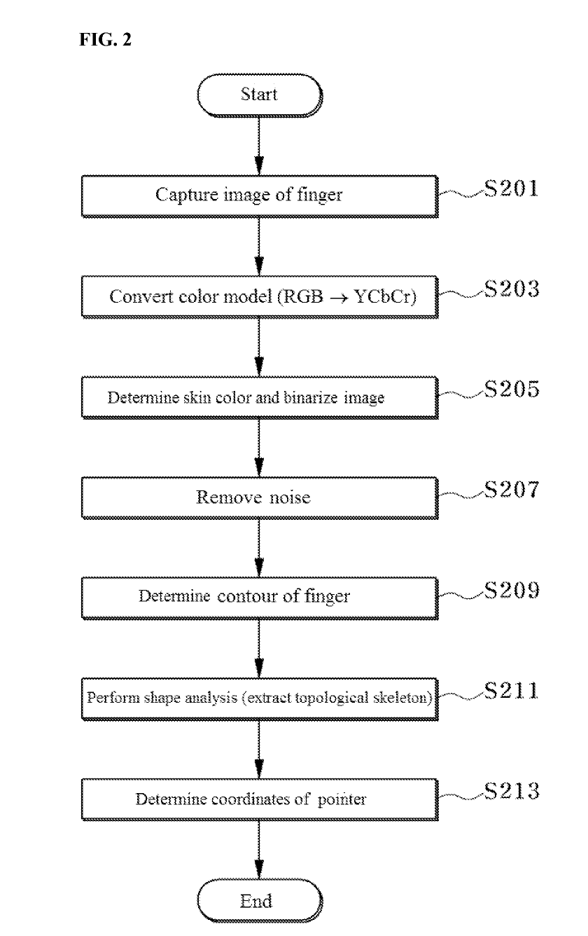

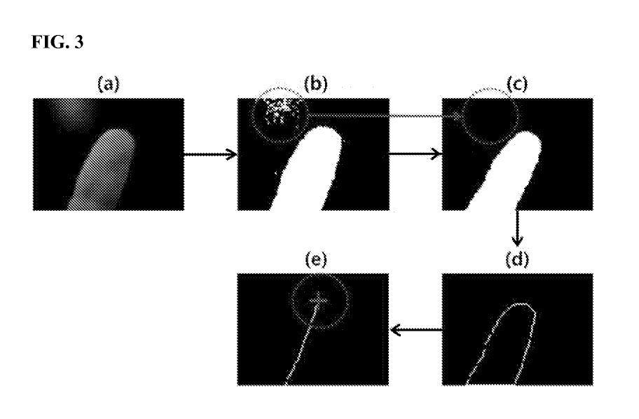

Subsequently, coordinates of the pointer may be determined from the topological skeleton data. The step of pre-processing the image according to the binarization will be described in detail with reference to FIGS. 2 and 3. On the other hand, it will be described that, in an example, the location of the pointer is extracted from the image of the finger. In this example, the “finger motion” may be equated to the “pointer motion” because the pointer is moved in correlation with the movement of the finger.

In an example of a mobile device that allows a user to initiate a control command based on the movement of a finger, the method of recognizing a control command according to the movement of the pointer motions may be performed in steps S111 to S127.

In step S111, a change in the image of a finger is observed to determine the movement of the pointer according to the finger motion. In this example, the observation involves recognizing a change in coordinates of the finger in each frame of the captured images of the finger.

In step S115, a user's intent to change the position of a pointer may be determined by comparing a position of the pointer, as determined from the captured image, between the frames to a position of the pointer in a previous frame. In step S117, the mobile device may detect the motion of the pointer measured in step S115 to be an upward, downward, left, or right control command according to the direction of the motion when the coordinates of the pointer are measured as a value that gradually changes in a comparison to the previous frame.

In the event that the contour of the finger region extracted in step S105 is observed to rapidly change in step S111, an increase or a decrease in an area of the finger may be detected in step S119, and an operation of the pointer may be recognized as a control command for clicking an object in step S121. For instance, a distance between the finger and the image capturing apparatus is decreased when the index finger is bent, and the finger region may rapidly dilate in the captured image of the finger. For example, the size of the finger may increase in the captured image as the distance between the finger and the image capturing apparatus decreases. The mobile device can, for example, recognize such a change in the captured image produced by the bending of the index finger as a click operation that corresponding to a mouse click during an operation of a personal computer (PC). A “rapid change” may refer to a bending motion of the finger in less than 1 second, or less than 500 milliseconds, or a directional movement of the finger covering more than 1 cm in less than 1 second, or less than 500 milliseconds, for instance. In another example, the object on a mobile device screen may be an operation target object on an application such as an icon of an application program of the mobile device.

The change in the pointer position as determined from the processing of the captured image is detected in step S111. When the pointer is positioned on the object by the movement of a finger, the length of time for which the pointer is positioned on the object is determined in step S123. When the determined length of time is greater than or equal to a predetermined length of time, the operation of the pointer is recognized as a control command for selecting the object in step S125. At this time, the selection command corresponds to an operation of clicking and gripping the object when a drag and drop operation is performed. In one example, a vibration feedback may be generated by the mobile device when the object is gripped to inform the user, for example, so that the user can easily recognize that the object is gripped according to the drag and drop operation.

Thus, it is possible for a user to easily control the mobile device and content implemented on the mobile device by using the pointer control commands recognized in steps S117, S121, and S125.

FIG. 2 is a flowchart illustrating an example of a method of recognizing a pointer location from the movement of a finger, and FIG. 3 is a diagram illustrating an example of a method in which a pointer location is correlated to a region of a finger.

Hereinafter, a method of recognizing a control command based on the movement of a finger and a set of control commands corresponding to various movements of the finger will be described. Examples of mobile devices and the controlling of content on such mobile devices will be also described.

As illustrated in FIG. 2, a method of recognizing the pointer according to the movement of a finger motion in front of an image capturing apparatus includes step S201 of acquiring an image of the finger. For example, the image capturing may involve acquiring information regarding the gesture of an index finger that has a high degree of freedom even when the hand is holding a mobile device. The image of the finger may be captured by using a fixed or removable image capturing apparatus provided on the front or the back of a mobile device. In step S203, a red, green, and blue (RGB) color model of the image may be converted into a YCbCr color model based on a signal of the captured image so as to extract a skin color region from the image and to obtain a binary image. In step S205, a region of the skin having certain color may be extracted as a skin color region using a threshold value, and the captured image may be binarized. In step S207 of removing noise, the noise may be removed from the image by applying a dilation operation and an erosion operation. In step S209 of determining a contour of the finger region, an outer contour of the finger may be determined from the image of the finger. In step S211 of extracting a topological skeleton, the topological skeleton data may be extracted based on the contour of the finger determined in step S209 using a shape analysis. In step S213 of determining the coordinates of the pointer, the location of the pointer may be determined from of the image of finger based on the topological skeleton information.

In addition, in order to perform the steps included in the method in accordance with the examples derived above, the mobile device in which the method of recognizing the pointer according to the finger motion is performed can include not only the fixed or removable image capturing apparatus on the back of the mobile device, but also a color model conversion unit for converting the RGB color model of the captured image into the YCbCr color model, a skin color region extraction unit for extracting a skin color region, an image binarization unit for binarizing the captured image, an image noise removal unit for removing the noise of the image, a finger region contour extraction unit for extracting the contour of the finger region, a skeletonization unit for performing skeletonization (extracting a topological skeleton), and a finger region pointer extraction unit for extracting the pointer of the finger region implemented as hardware or software.

In color model conversion step S203, the image of a region of the hand, such as the tip of a finger that is obtained based on the RGB color model is converted into the YCbCr color model.

In step S205 of determining the skin color and performing the binarization as the pre-processing step for detecting the finger region, threshold values for Cb and Cr values are applied and their criteria are expressed as shown in Expression (1).

$$Finger Color ( x , y ) = \{ \begin{matrix}255 & if ( α \leq Cb \leq β ) ⋂ ( δ \leq Cr \leq σ ) \\ 0 & Otherwise\end{matrix} \qquad ( 1 )$$

In experiments in accordance with an example of the above described methods, successful results were derived by applying values of 77≦Cb≦127 and 133≦Cr≦137. However, these results are only one example provided for illustrative purposes, and the claims are not to be construed as limited thereto. In accordance with the example, the threshold value for detection may be changed in consideration of various skin colors. The technical scope, core configuration, and function of the present invention are not limited by boundary values of the threshold values for the Cb and Cr values. If a skin color region is detected using the threshold values for the skin color region, the skin color region is identified to be the finger region and binarization of the finger region against a background is performed.

In image noise removal step S207, the dilation operation and the erosion operation can be used in consideration of a decrease in a calculation speed according to low computing power of the portable information device and a decrease in the finger region when noise is removed so as to more accurately detect a region of interest from the image of the finger including the finger region on the back and remove an unnecessary object or noise or the like.

Assuming that A and B are pixel sets in the dilation operation, A⊕B for dilating A by a structuring element B can be defined as shown in Expression (2).

$$A ⊕ B = {⋃}_{W ∈ B} {A}_{W} = ( a , b ) + ( u , v ) : ( a , b ) ∈ A , ( u , v ) ∈ B \qquad ( 2 )$$

The dilation operation is mainly used to fill holes occurring in an object or a background or bridge short gaps by decreasing a protrusion within the object and increasing an external protrusion. In the binary image, the dilation operation is carried out to change a region in which black and white pixels are positioned together without changing a region in which input pixels are uniform.

Assuming that A and B are pixel sets in the erosion operation, A⊖B for eroding A by a structuring element B can be defined as shown in Expression (3).

A⊖B=w:B_{w}⊂A (3)

Here, B_{w} represents a result occurring due to erosion of a set of w=(u, v) completely included in the set A as a result obtained by moving the structuring element B. That is, an operation of finding positions in which B is completely included while B moves onto A, collecting points corresponding to the origin in positions, and creating a set of the collected points can be defined as the erosion operation.

The dilation operation and the erosion operation are provided merely as examples of methods which may be used for illustrative purposes, and other methods may be used in other examples. For example, a method based on a Gaussian probability density function in a wavelet region, a spatial filtering method including a sequential filter, a mean filter, and the like, and image noise reduction and cancelation technology using a Wiener filter and the like applied to existing image processing technology may be applied instead of the dilation operation and the erosion operation, or additionally applied with the dilation operation and the erosion operation. However, the technical scope, core configuration, and function of the methods described herein are not limited thereto.

To determine the location of the intended location of the pointer based on a finger image, a region of the image that depicts the finger may be extracted from the entire image, and the location of the pointer may be acquired and recognized according to the motion of the finger while the hand is holding the mobile device. In addition, it is necessary to reconfigure 2D plane and multi-dimensional finger models so as to track and analyze distances (coordinate conversion) of continuous multi-dimensional motions of the finger.

Accordingly, in one example, the original image of the finger is captured using an image capturing apparatus provided on the back of the mobile device, as illustrated in FIG. 3(a) (S201). The detection of finger region and the binarization of the image as illustrated in FIG. 3(b) may be performed (S205) after the conversion of a color model for the original image (S203). The noise may be removed from the image as illustrated in FIG. 3(c) (S207). In this example, the noise is removed from a circle indicated by a dotted line in FIG. 3(b). As a result, it can be seen that there is no noise within a circle indicated by a dotted line in FIG. 3(c). Thereafter, a contour of the finger region as illustrated in FIG. 3(d) is extracted (S209), and the pointer of the finger is acquired by performing skeletonization based on the contour of the finger extracted as illustrated in FIG. 3(e). A portion indicated by a mark “+” within a circle indicated by a dotted line in FIG. 3(e) becomes the pointer of the finger.

As described above, topological skeleton information is estimated by a shape analysis such as in the skeletonization in step S211. The skeletonization or the extraction of the topological skeleton may be performed as defined by Expression (4). This skeletonization is an iterative process of pixel removal as an algorithm of finding a center line of an object, and is mainly used to analyze an image or recognize a character.

C(i)=(P_{L}(i)+P_{R}(i))/2,i=0,1, . . . ,Maxrow (4)

The iterative process of pixel removal is a process of removing outer pixels of the object within each image included in a video, and a pixel removal process is iterated until there are no more pixels to be removed. In the entire calculation process, as seen from Expression (4), a center pixel is found in consideration of only a leftmost pixel P_{L} of the object, that is, the finger region, and a rightmost pixel P_{R} of the finger region. Here, Maxrow denotes a size of a row in the image and C denotes a center-line pixel.

A tip portion of the topological skeleton of the finger region extracted by the skeletonization is replaced with a pointer region of the finger. In the topological skeleton image, position coordinates are changed according to finger motion. This skeletonization may be one method capable of acquiring a change value of the pointer. The change in the pointer is extracted as a representative characteristic necessarily accompanied with the finger motion. It is possible to directly control the mobile device and its content through finger motions occurring in the back of the mobile device by simultaneously providing the user with visual effects of a movement path of motion, selection, and the like on a front-side panel. In addition, because this function can be used independent of or in combination with an existing mobile device control method and function as in a touch screen panel, a keypad, and the like, it is possible to provide a more convenient and efficient user environment by enabling the portable information device to be operated and controlled with only one hand of the user holding onto the mobile device.

The method of determining the position of a pointer according to the movement of a finger in front of an image capturing apparatus of a mobile device in accordance with various examples has been described above. Hereinafter, a mobile device and a method of generating and recognizing a control command for controlling embedded related content using the recognized pointer will be described.

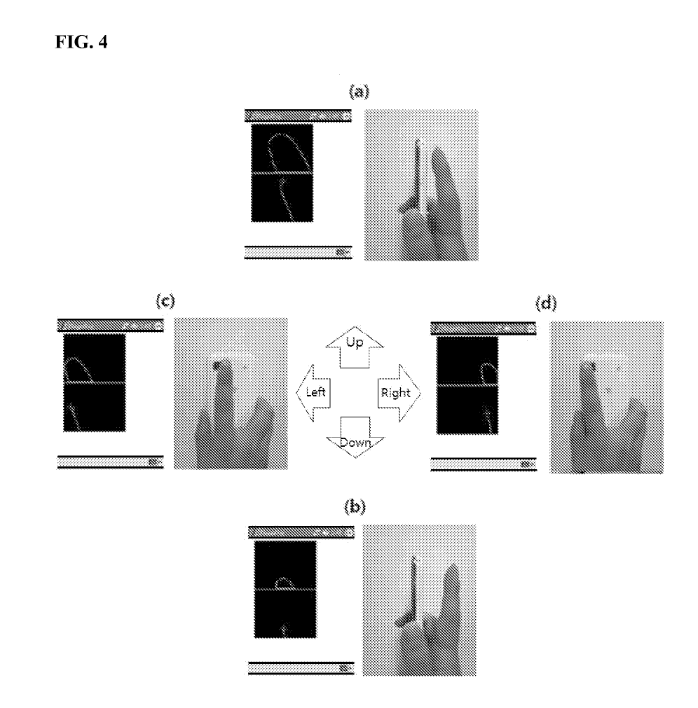

FIG. 4 is a diagram illustrating an example of a method of recognizing the movement of pointer movement control command.

In an example of the acquisition and recognition of a pointer according to finger motion, a degree of a change in the finger motion may be observed based on a change in the position of the pointer. From the observed degree of change, a control command such as up, down, left, or right selection (click) can be generated along with visual effect for motion of a cursor or pointing of a mouse. As an example, in a mobile device in which the embedded contents may be controlled by a finger motion, the above-described five types of control commands may be configured in consideration of the characteristics of the image capturing apparatus provided on the mobile device and a range of the finger motion or the expression of a gesture.

FIG. 4 is a diagram illustrating an example of a method for simple cursor movement control. FIG. 4(a) illustrates a method for recognizing the movement of a cursor in the upward direction. FIG. 4(b) illustrates a method of recognizing the movement of a cursor in the downward direction. FIG. 4(c) illustrates a method for recognizing the movement of a cursor to the left. FIG. 4(d) illustrates a method for recognizing the movement of a cursor to the right.

The simple cursor movement control is triggered when it is determined that none of the other control commands, such as the selection command, is recognized as being performed by the user. As illustrated in FIG. 4, in terms of the upward, downward, left, and right movements of the cursor based on a change in the coordinates of the pointer according to the finger motion, a tip point of a central line in the image of the finger, such as the tip point of a skeletonization line of a finger image as determined by a shape analysis, may be displayed on a screen of the mobile device as a pointer, and a position of the cursor may be also distributed in an upper portion of the screen when a distance between the finger and the image capturing apparatus provided on the mobile device is short. In this example, the image capturing apparatus may be provided on the back of the mobile device. However, the position of the image capturing apparatus on the mobile device is not limited thereto.

On the other hand, it can be seen that the position of the pointer of the object may be distributed in a lower portion when a distance from the center of the finger is long. Accordingly, in terms of the upward and downward movements of the pointer, the intended movement may be determined to be in the upward direction if the distance between the image capturing apparatus and the finger becomes shorter, and the intended movement may be determined to be in the downward direction if the distance becomes longer. At this time, corresponding coordinates may be used as a movement position of the cursor and displayed on the screen of the mobile device. In addition, when left or right motion of the finger is used, the user acquires the pointer of the finger region moving in the left or right direction using the image capturing apparatus provided on the mobile device, and corresponding coordinates are used as a movement position of the cursor. The coordinates of the pointer detected as described above are recognized as the movement position of the cursor and displayed on the screen of the mobile device.

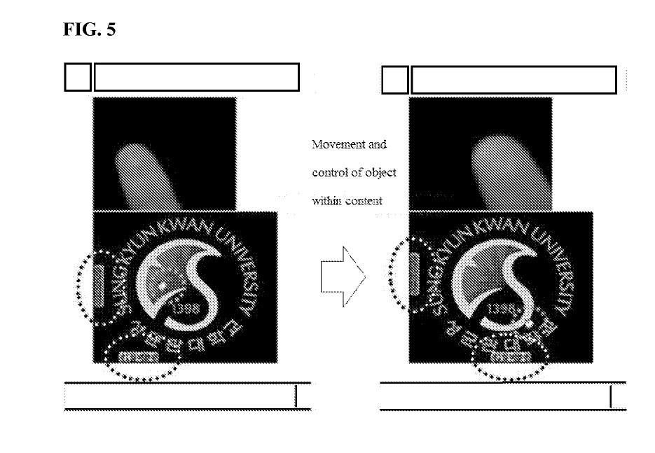

FIG. 5 is a diagram illustrating a method of controlling an object according to the movement of a pointer by a finger motion. In FIG. 5, a process of acquiring the pointer location of a finger from a rear-facing camera and moving a control bar within content in an upward, downward, left, or right direction according to the acquired pointer is illustrated as an example in which the control bar may be moved using the movement of the finger in front of the camera.

FIG. 6 is a diagram illustrating an example of a method of recognizing a click control command. The method of recognizing a click control command based on the movement of a finger will be described with reference to FIG. 6.

A control command can be generated using various characteristics of a pointer and a rapid change in finger motion or a gesture when a control command for controlling the mobile device or selecting or executing embedded related content is generated, such as, when a selection function similar to a window-based click or double-click function is controlled.

For example, in a mobile device illustrated in FIG. 6, when an index finger of a hand grasping the mobile device is exposed to and then bent toward the image capturing apparatus for a certain length of time, the pointer of the finger region moves in the downward direction. After the movement of the pointer in the upward direction if the index finger is re-extended, the pointer can be re-acquired. Accordingly, when the pointer rapidly changes between frames for the index finger, the change can be recognized and used as a control command for controlling the mobile device or selecting or executing the embedded related content.

In other words, when a specific finger is exposed to the image capturing apparatus and bent in a state in which pointer recognition is being performed, the point moves in the downward direction as illustrated in FIG. 6(a). When the pointer moves in the upward direction as illustrated in FIG. 6(b) and (c), and the movement range between frames is larger than a reference range α, a click control command may be recognized and used as the control command.

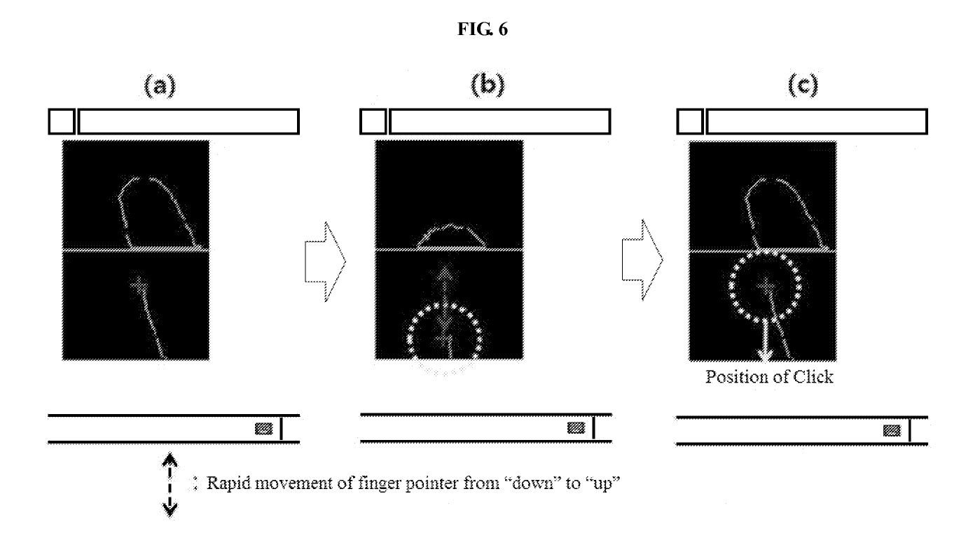

FIGS. 7 to 10 are diagrams illustrating examples of methods of recognizing “up,” “down,” “right,” and “left” control commands, respectively.

In order to recognize the “up,” “down,” “left,” and “right” control commands, changes in the pointer are observed as in FIGS. 7 to 10, and mapped to the “up,” “down,” “left,” and “right” control commands using chessboard distances. When coordinates of a previous frame pointer are (i₁, j₁) and coordinates of a current frame pointer are (i₂, j₂), the chessboard distance is defined as shown in Expression (5).

d_{chess}=max(i₂−i_{I}|,|j₂−j₁|) (5)

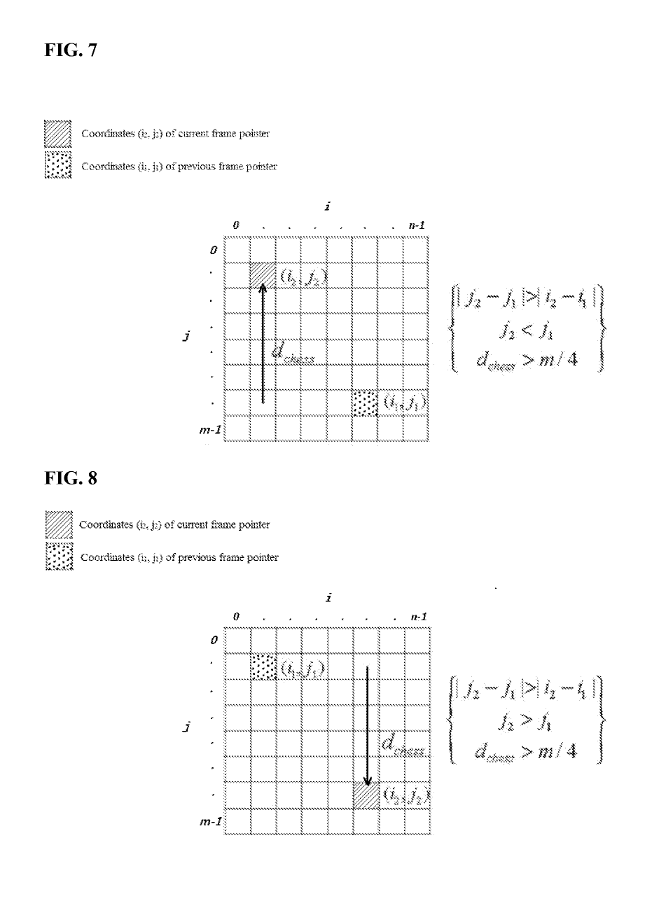

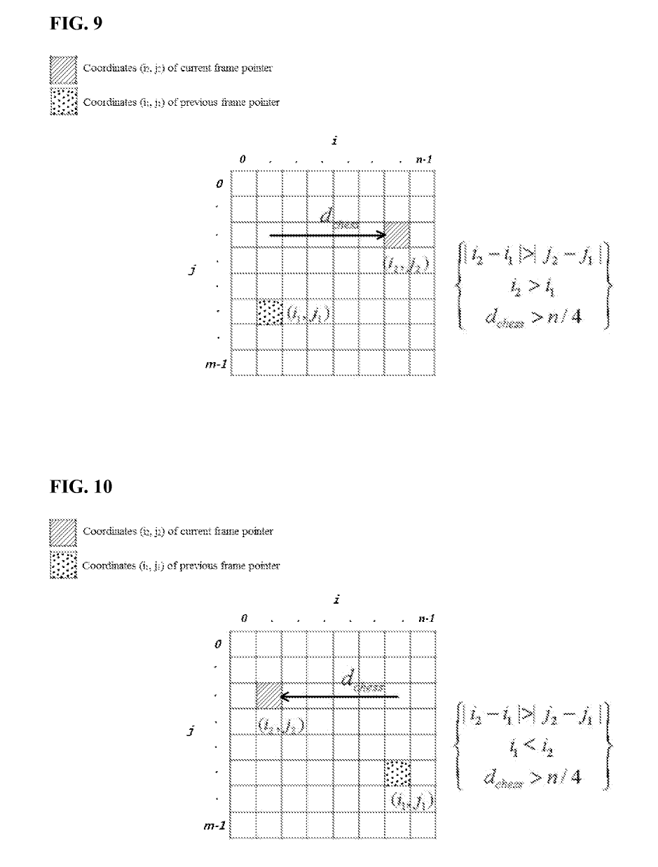

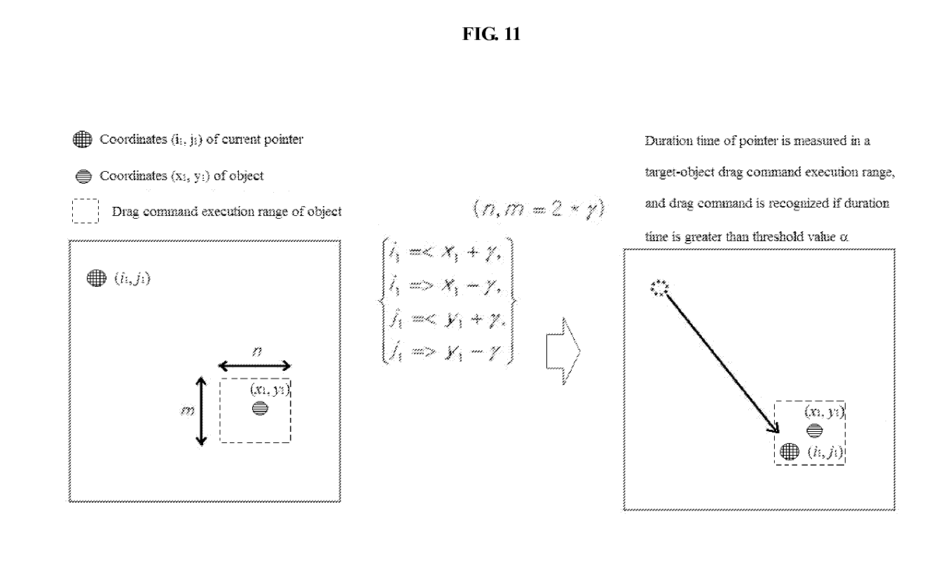

As an example of the generation of the “up,” “down,” “left,” and “right” control commands, when |j₂−j₁|>|i₂−i₁| and d_{chess}>m/4 in Expression (5) in a frame of the camera having a resolution of n×m, mapping to the “up” and “down” control commands is performed. If j₂<j₁ as illustrated in FIG. 7, the “up” control command can be defined. If j₂>j₁ as illustrated in FIG. 8, the “down” control command can be defined. Likewise, when |i₂−i₁|>j₂−j₁| and d_{chess}>n/4 in Expression (5) in a frame of the camera having a resolution of n×m, mapping to the “left” and “right” control commands is performed. If i₂>i₁ as illustrated in FIG. 9, the “right” control command can be defined. If i₂<i₁ as illustrated in FIG. 10, the “left” control command can be defined.

If the control command is defined as described above, the portable information device measures a movement pixel change amount and a direction of a pointer between frames. For instance, the portable information device may measure the amount of a position change of the pointer and a movement direction of the pointer between the frames, and may recognize a control command in consideration of the movement direction of the pointer when the amount of position change is greater than a reference change amount. For example, the reference change amount may be set to m/4 in the up/down movement direction and n/4 in the left/right movement direction as illustrated in FIGS. 7 to 10.

These control commands can be utilized not only as control commands for direction movement in which content moves in the upward, downward, left, and right directions using a speed change of the pointer, but also as control commands for command execution of a shortcut key concept by making mapping to specific control commands independent of the upward, downward, left, and right directions.

Although an example of the above-described method of generating and recognizing a command for controlling the mobile device and content has been described, the technical scope, core configuration, and function of the present invention are not limited thereto. For example, it is also possible to generate a control command such as “zoom-in” or “zoom-out” using the pointer in addition to the above-described control commands.

In an example of a mobile device, a change in a pointer generated due to the a movement of the finger in front of the image capturing apparatus of the mobile device and a change in an area of the finger in the captured image according to a distance change between the finger and the image capturing apparatus may be recognized as a control command such as a touch or double touch, and the recognition results can be presented as visual effects such as pointing of the mouse on the screen of the mobile device. The mobile device may further include an input mode determination unit to be used independently or in combination with a representative user interface such as a touch screen or a keypad when system control and operation commands and the like are input. The input mode determination unit also determines whether or not there is an input using gesture recognition of the finger in front of the image capturing apparatus of the mobile device. A control command input by a user in front of the image capturing apparatus may be displayed on the screen of the mobile device. For example, the image capturing apparatus can be located on the rear of the mobile device, and the control command can be displayed on an LCD panel on the front side of the mobile device.

FIG. 11 is a diagram illustrating an example of a method of recognizing a drag and drop control command.

In this example, an operation of a pointer is recognized as a control command that selects an object when the pointer is positioned for a predetermined time or more on the object. At this time, a selection command corresponds to an operation of clicking and gripping the object when a drag and drop operation is performed. In one example of the mobile device, vibration feedback may be performed when the object is gripped. From the vibration, the user can easily recognize that a desired object to be dragged and dropped has been gripped. When a given frame time (for example, within 1 sec) has elapsed in a state in which the pointer is in a range (for example, ±25 pixels) of the object, the vibration feedback may be performed. That is, when coordinates of a current pointer are (i₁, j₁) and coordinates of a target object are (x₁, y₁), the object is gripped for a drag command while vibration is generated when coordinates of the pointer are in a range of i₁≦x₁+γ, i₁≧x₁−γ, j₁≦y₁+γ, and j₂≧y₂−γ, and the object selected by moving the finger may be dragged. In the case of drop command recognition, the dragged object can be dropped after a predetermined time or more by moving the object to a desired position in which the dragged object is dropped. When the drop command is also performed, vibration feedback can be performed. Although the drag command range in which the pointer is positioned on the object is rectangular in this example, the drag command range can be appropriately modified in the form of a circle or an oval in other examples.

Some examples of mobile devices described above have certain advantages. However, this does not mean that a specific example of mobile device should include all of the described advantages or include only these advantages. The scope of the disclosed technology is not limited to these advantages.

In terms of the pointer control command recognition method according to finger motions and the mobile device for controlling the pointer according to finger motions in accordance with one example, the mobile device can be controlled according to a simple operation of the finger without a physical contact. In addition, it may be possible to control the mobile device in various methods by recognizing the drag and drop command, and it may be possible to perform an accurate operation because a vibration feedback may be provided from the mobile device when the drag and drop operation is performed.

As a non-exhaustive illustration only, a mobile device described herein may refer to devices such as a cellular phone, a personal digital assistant (PDA), a digital camera, a portable game console, and an MP3 player, a portable/personal multimedia player (PMP), a handheld e-book, a handheld video game console, a portable lab-top PC, a global positioning system (GPS) navigation, and devices such as a desktop PC, a high definition television (HDTV), an optical disc player, a setup box, and the like capable of wireless communication or network communication consistent with that disclosed herein.

A mobile device may include a display screen, such as an LCD screen, a computing system, computer processor, memory storage, wireless communication terminal, a microphone, a camera, etc.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A mobile device may comprise a plurality of units. The units described herein may be implemented using hardware components and software components. For example, microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors. As used herein, a processing device configured to implement a function A includes a processor programmed to run specific software. In addition, a processing device configured to implement a function A, a function B, and a function C may include configurations, such as, for example, a processor configured to implement both functions A, B, and C, a first processor configured to implement function A, and a second processor configured to implement functions B and C, a first processor to implement function A, a second processor configured to implement function B, and a third processor configured to implement function C, a first processor configured to implement function A, and a second processor configured to implement functions B and C, a first processor configured to implement functions A, B, C, and a second processor configured to implement functions A, B, and C, and so on.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device.

The software also may be distributed over network coupled computer systems so that the software is stored and executed in a distributed fashion. In particular, the software and data may be stored by one or more computer readable recording mediums. The computer readable recording medium may include any data storage device that can store data which can be thereafter read by a computer system or processing device. Examples of the computer readable recording medium include read-only memory (ROM), random-access memory (RAM), CD-ROMs, magnetic tapes, floppy disks, optical data storage devices. Also, functional programs, codes, and code segments for accomplishing the examples disclosed herein can be easily construed by programmers skilled in the art to which the examples pertain based on and using the flow diagrams and block diagrams of the figures and their corresponding descriptions as provided herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of recognizing a control command from a finger movement detected from an image capturing apparatus of a mobile device, comprising:
capturing an image of a finger;
determining a contour of the finger from the captured image;
determining coordinates of a pointer that corresponds to a region of the finger based on the contour; and
recognizing a control command based on a movement direction of the finger, a length of time for which the pointer is positioned on an object, or a change in the contour of the finger.

2. The method of claim 1, wherein the control command corresponding to the length of time for which the pointer is positioned on the object is an object selection command to drag and drop the object, and the object selection command is triggered in response to the pointer being positioned on the object for a predetermined length of time or more.

3. The method of claim 2, wherein the mobile device is configured to perform a vibration feedback when the pointer is positioned on the object for the predetermined length of time or more.

4. The method of claim 1, wherein:
the determining of the contour includes determining a region of the captured image depicting the finger based on a threshold value indicating a skin color, removing noise by binarizing the image, and determining the contour of the finger from the image from which the noise is removed, and
the determining of the coordinates of the pointer includes a shape analysis in which a central line of the finger is determined from the contour, and associating of a tip portion of the central line with the coordinates of the pointer.

5. The method of claim 1, wherein the control command corresponding to the change in the contour of the finger is a command in which the object is clicked with the pointer when a size of the finger is determined to increase or decrease based on the contour while the pointer is positioned on the object.

6. The method of claim 1, wherein the recognizing of a control command further includes recognizing an operation of the pointer as a control command for clicking the object when there is a frame having a rapid change in a size of the finger among frames constituting images including the finger.

7. A mobile device for recognizing a control command based on an image of a finger, comprising:
an image capturing unit configured to capture an image including a finger;
a pointer extraction unit configured to determine a contour of the finger from the captured image and determine coordinates of a pointer that corresponds to a region of the finger based on the contour; and
a control command generation unit configured to generate a control command based on a movement direction of the pointer, a length of time for which the pointer is positioned on an object, or a change in the contour of the finger.

8. The mobile device of claim 7, wherein the control command generation unit is configured to generate an object selection command to drag and drop the object with the pointer in response to the pointer being positioned on the object for a predetermined length of time or more.

9. The mobile device of claim 8, wherein the control command generation unit is configured to perform a vibration feedback when generating the object selection command.

10. The mobile device of claim 7, wherein the pointer extraction unit is configured to determine a region of the image corresponding to the finger based on a threshold value indicating a skin color, to remove noise by binarizing the image, and to determine the contour of the finger from the image from which the noise has been removed, to perform a shape analysis to determine a central line of the finger and to associate a tip portion of the central line of the finger with coordinates of the pointer.

11. The mobile device of claim 7, wherein the control command generation unit is configured to generate a control command for clicking the object when a size of the finger is determined to increase or decrease based on the contour while positioned on the object among frames constituting images including the finger.

12. A mobile device for recognizing a control command based on an image of a finger, comprising:
an image capturing unit configured to capture an image including a finger; and
a processing unit configured to determine a contour of the finger from the captured image and determine coordinates of a pointer corresponding to a region of the finger based on the contour,
wherein the processing unit is configured to generate an object selection command to drag and drop an object with the pointer in response to the pointer being positioned on the object for a predetermined length of time or more, and to generate an object drop command in response to a predetermined length of time or more having elapsed after position movement by dragging the object.

13. The mobile device of claim 12, wherein the selection command and the drop command include a vibration feedback.

14. The mobile device of claim 12, wherein the coordinates of the pointer is determined by applying a shape analysis to the contour of the finger.

15. The mobile device of claim 14, wherein the shape analysis is a skeletonization to determine a topological skeleton from the contour.
